(19) United States
(12) Patent Application Publication
(10) Pub. No.: US 2013/0220084 A1
(43) Pub. Date: Aug. 29, 2013

(54) Wrench

(71) Applicant: KABO TOOL COMPANY, (US)

(72) Inventor: Chih-Ching HSIEH, Taichung City (TW)

(73) Assignee: KABO TOOL COMPANY, Taichung City (TW)

(21) Appl. No.: 13/761,141

(22) Filed: Feb. 6, 2013

(30) Foreign Application Priority Data
Feb. 23, 2012 (TW) 101203307

(51) Int. Cl. B25B 23/16

(52) U.S. Cl. CPC B25B 23/16
USPC 81/177.1

(57) ABSTRACT

A wrench including a handle, an open drive portion, and a closed drive portion is provided. The open drive portion and the closed drive portion are located at two ends of the handle, respectively. The handle includes a first side, a second side, and two recessed structures. The second side is opposite to the first side. The recessed structures are formed on the first side and the second side, respectively. The recessed structures are near the ends of the handle, respectively. Both the open drive portion and the closed drive portion have an abutting plane. Each abutting plane forms an angle with an extending axis of the handle.

### RELATED APPLICATIONS

The application claims priority to Taiwan Application Serial Number 101203307, filed Feb. 23, 2012, which is herein incorporated by reference.

### BACKGROUND

1. Field of Invention

The present disclosure relates to a hand tool. More particularly, the present disclosure relates to a wrench.

2. Description of Related Art

Wrench is widely used and necessary for a common family or plant. However, slipping during operation has been a problem for general wrenches.

A conventional wrench as disclosed in Taiwan Patent No. M240308 entitled: ratchet wrench with skidproof stem sheath, is provided to prevent slipping. The conventional wrench prevents slipping by a rubber sheath which integrally formed thereon. The rubber sheath is less effective during actual operation because it does not cover a junction between a driving head and a handle of the conventional wrench. In general, users are used to pressing the junction by thumb and index finger besides holding the handle, Therefore, the conventional wrench still has the problem of slipping even making the users get hurt.

Furthermore, the rubber sheath of the conventional wrench is easily damaged by other hand tools when these tools are kept together and would become harden and brittle once touching lubricant or oil that deteriorate anti-slip capability of the conventional wrench as well as result in less effect in preventing slipping.

Other conventional wrenches which prevent slipping by an anti-slip structure formed thereon such as an embossed pattern are less effective as well because the anti-slip structure has worse appearance and uncomfortable gripping feel and will resist shifting the fingers as needed during operation.

### SUMMARY

According to one aspect of the present disclosure, a wrench includes a handle, an open drive portion, and a closed drive portion. The handle includes a first side, a second side, a first recessed structure, and a second recessed structure. The second side is opposite to the first side. The first recessed structure is formed on the first side. The second recessed structure is formed on the second side, wherein the first recessed structure and the second recessed structure are near two ends of the handle, respectively. The open drive portion is located at the end of the handle and the closed drive portion is located at the other end of the handle. The first side is toward a working direction of the open drive portion. A maximum distance in parallel with an extending axis of the handle between the open drive portion and the closed drive portion is Mi. A maximum distance in parallel with the extending axis of the handle between the first recessed structure and the second recessed structure is M2, and M2/M1 is 0.45-0.8.

According to another aspect of the present disclosure, a wrench includes a handle, an open drive portion, and closed drive portion. The handle includes a first side, a second side, a first recessed structure, and a second recessed structure. The second side is opposite to the first side. The first recessed structure is formed on the first side. The second recessed structure is formed on the second side, wherein the first recessed structure and the second recessed structure are near two ends of the handle, respectively. The open drive portion has a first abutting plane and is located at the end of the handle. The closed drive portion has a second abutting plane and is located at the other hand of the handle. A first angle is formed between the first abutting plane and an extending axis of the handle, a second angle is formed between the second abutting plane and the extending axis of the handle, and the first side is toward a working direction of the open drive portion. A maximum distance in parallel with the extending axis of the handle between the open drive portion and the closed drive portion is Mt A maximum distance in parallel with the extending axis of the handle between the first recessed structure and the second recessed structure is M2, and M2/M1 is 0.45-0.8.

### BRIEF DESCRIPTION OF THE DRAWINGS

The disclosure can be more fully understood by reading the following detailed description of the embodiment, with reference made to the accompanying drawings as follows:

FIG. 1 is a three dimensional view of a wrench according to one embodiment of the present disclosure;

FIG. 2A is a sectional view of the wrench of FIG. 1;

FIG. 2B is another three dimensional view of the wrench of FIG. 1;

FIG. 3 is a top view of the wrench of FIG. 1;

FIG. 4 is a side view of the wrench of FIG. 1;

FIG. 5 is a another side view of the wrench of FIG. 1;

FIG. 6 is a schematic view of the wrench of FIG. 1 in one operating mode;

FIG. 7 is a schematic view of the wrench of FIG. 1 in another operating mode; and

FIG. 8 is a schematic view of the wrench of FIG. 1 in still another operating mode.

### DETAILED DESCRIPTION

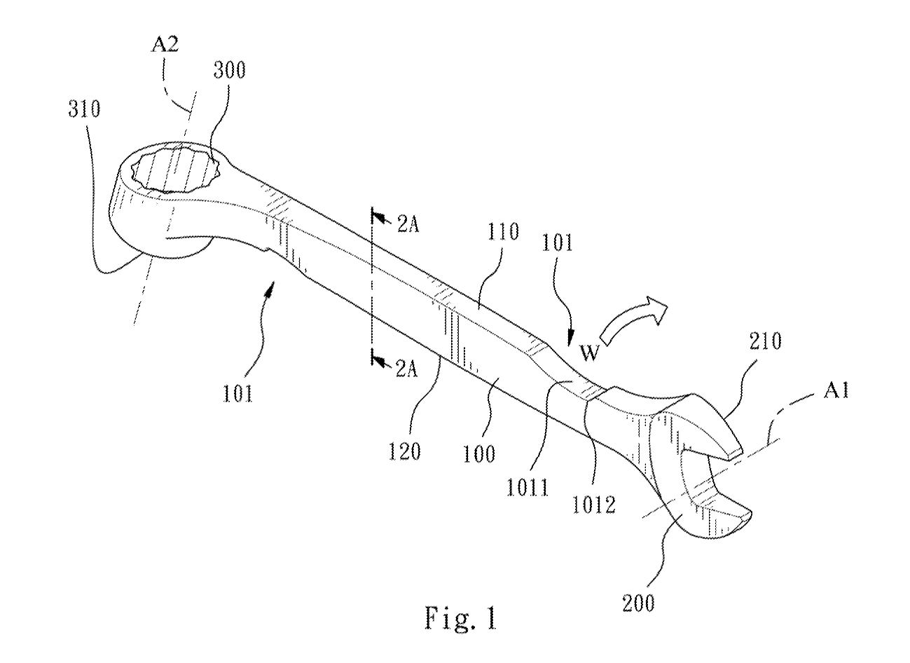

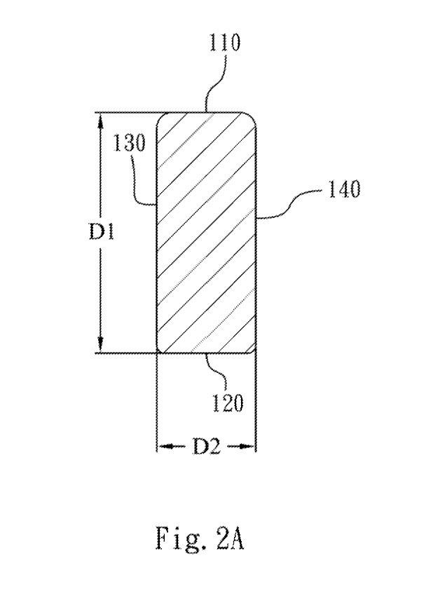

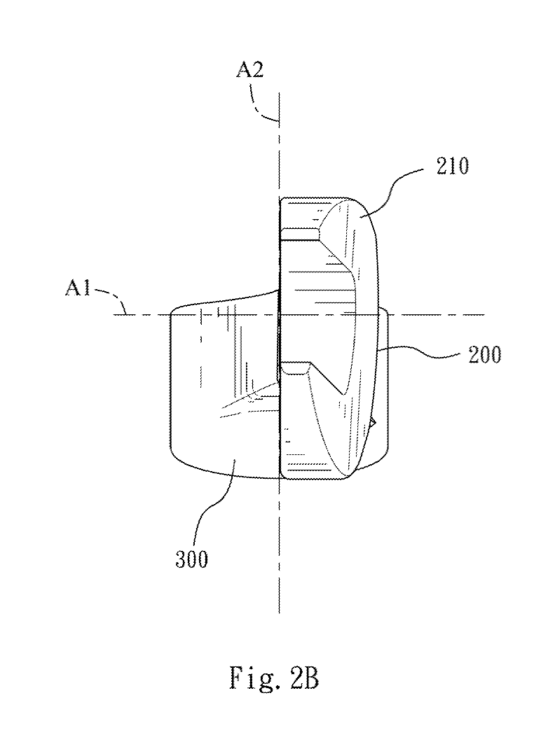

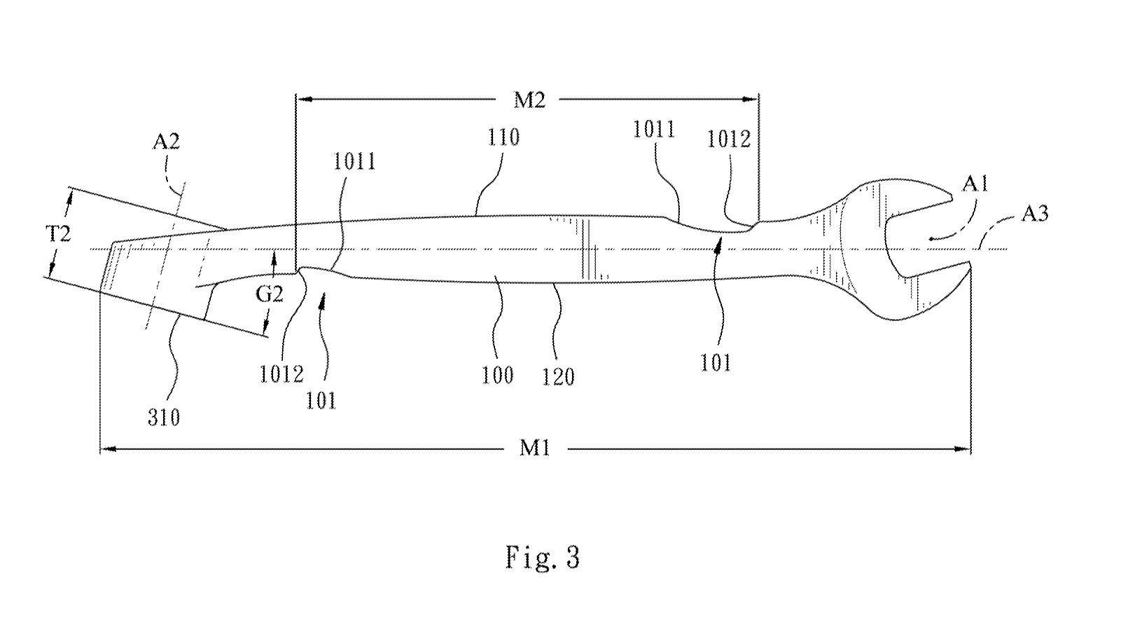

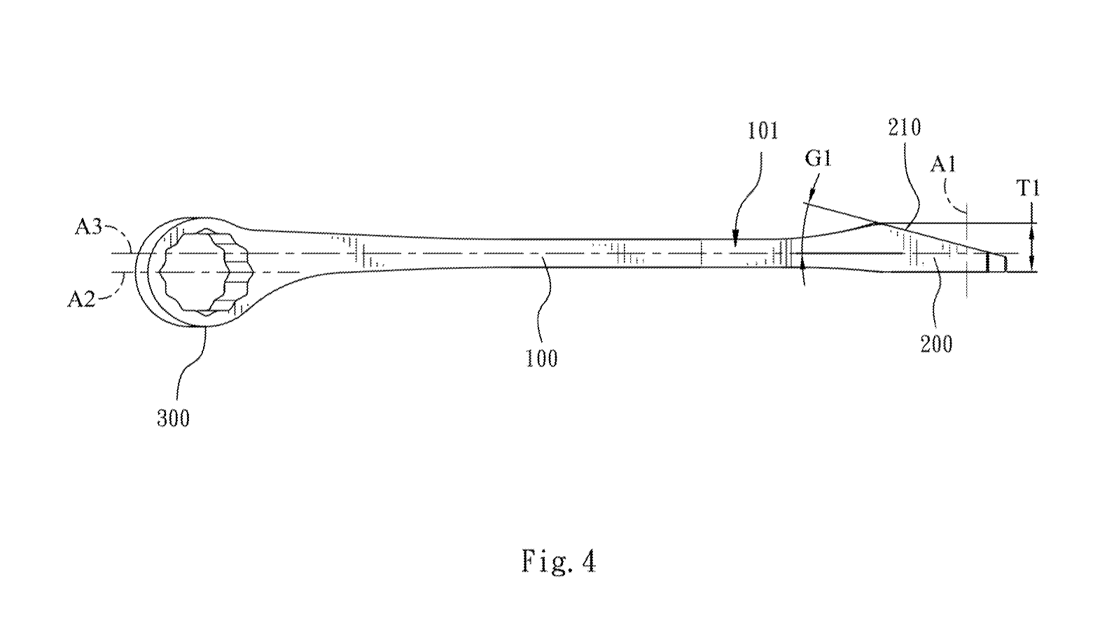

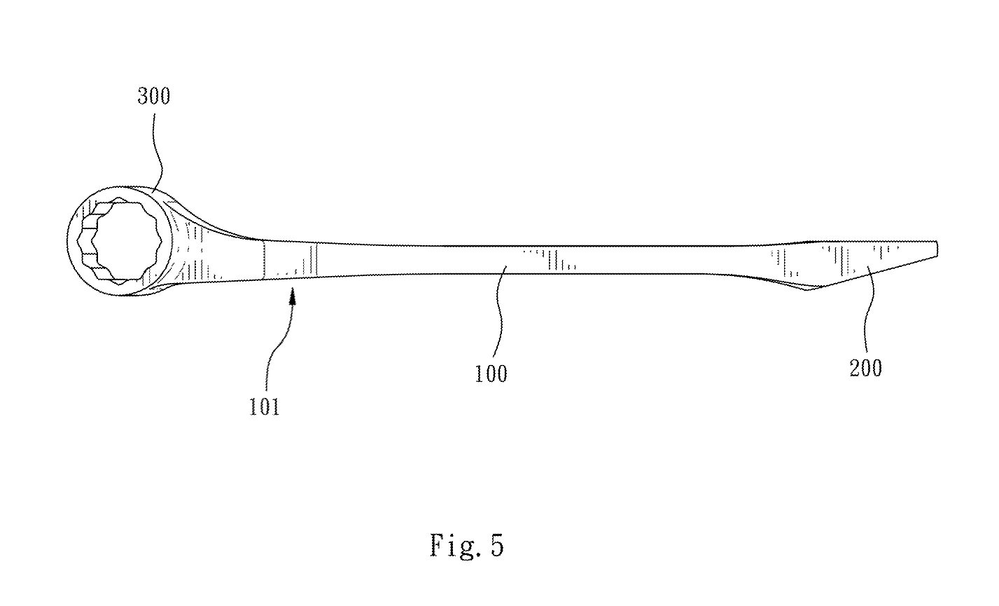

FIG. 1 is a three dimensional view of a wrench according to one embodiment of the present disclosure. Fig, 2A is a sectional view of the wrench of FIG. 1. FIG. 2B is another three dimensional view of the wrench of FIG. 1. FIGS. 3-5 are a top view, a side view, and another side view of the wrench of FIG. 1, respectively.

The wrench includes a handle 100, an open drive portion 200, and a closed drive portion 300. The handle 100, the open drive portion 200, and the closed drive portion 300 are integrally formed.

The handle 100 includes a first side 110, a second side 120, a third side 130, a fourth side 140, and two recessed structures 101. The second side 120 is opposite to the first side 110 and the fourth side 140 is opposite to the third side 130. Both the third side 130 and the fourth side 140 are connected to the first side 110 and the second side 120 and thus a quadrilateral shape of the handle 100 is formed. A distance D1 between the first side 110 and the second side 120 is greater than a distance D2 between the third side 130 and the fourth side 140. The handle 100 is sheet-formed and has two ends thereof. A width of the handle 100 at the third side 130 and the fourth side 140 is gradually decreased toward the ends of the handle 100. One of the recessed structures 101 is formed on the first side 110 and the other of the recessed structures 101 is formed on the second side 120. In addition, the recessed structures 101 are near the ends of the handle 100, respectively. Each recessed structure 101 includes a curved surface 1011 and a retaining surface 1012. The retaining surface 1020 connects the curved surface 1011.

In FIGS. 1, 2B, 3 and 4, the open drive portion 200 has a working axis A1 and is located at the end of the handle 100. The closed drive portion 300 has a working axis A2 and is located at the other end of the handle 100. The working axis A1 is perpendicular to the working axis A2. The first side 110 is toward a working direction W of the open drive portion 200. A thickness T1 of the open drive portion 200 parallel to the working axis A1 is gradually decreased from the end of the handle 100. A thickness T2 of the closed drive portion 300 parallel to the working axis A2 is gradually decreased from the other end of the handle 100. The working axis A1 of the open drive portion 200 does not meet an extending axis A3 of the handle 100. The working axis A2 of the closed drive portion 300 does not meet the extending axis A3 of the handle 100 as well. A maximum distance in parallel with the extending axis A3 of the handle 100 between the open drive portion 200 and the closed drive portion 300 is M1. A maximum distance in parallel with the extending axis A3 of the handle 100 between the recessed structures 101 is M2, wherein M2/M1 is 0.45-0.8 and preferably is 0.5-0.65. Thus, the wrench can offer a sufficient area for users to hold comfortably and apply force easily. For example, users thumb and little finger could be located between the recessed structures 101 while holding the wrench when M2/M1 is 0.45-0.8.

The recessed structures 101 which formed on the first side 110 and the second side 120 provide users an adequate space for placing their thumb or index finger during operation. Furthermore, the curved surface 1011 collaborating with the retaining surface 1012 will hook the thumb or the index finger of users to prevent slipping during operation. Thus, the wrench not only prevents slipping but also provides smoother operation for users.

In addition, the open drive portion 200 has an abutting plane 210 and the closed drive portion 300 has an abutting plane 310. An angle G1 is formed between the abutting plane 210 and the extending axis A3 of the handle 100. An angle G2 is formed between the abutting plane 310 and the extending axis A3 of the handle 100. The abutting plane 210 and the abutting plane 310 make the wrench keep an ergonomic operating angle. Thus, the wrench can be easily held and users can easily change the holding manner as needed during operation.

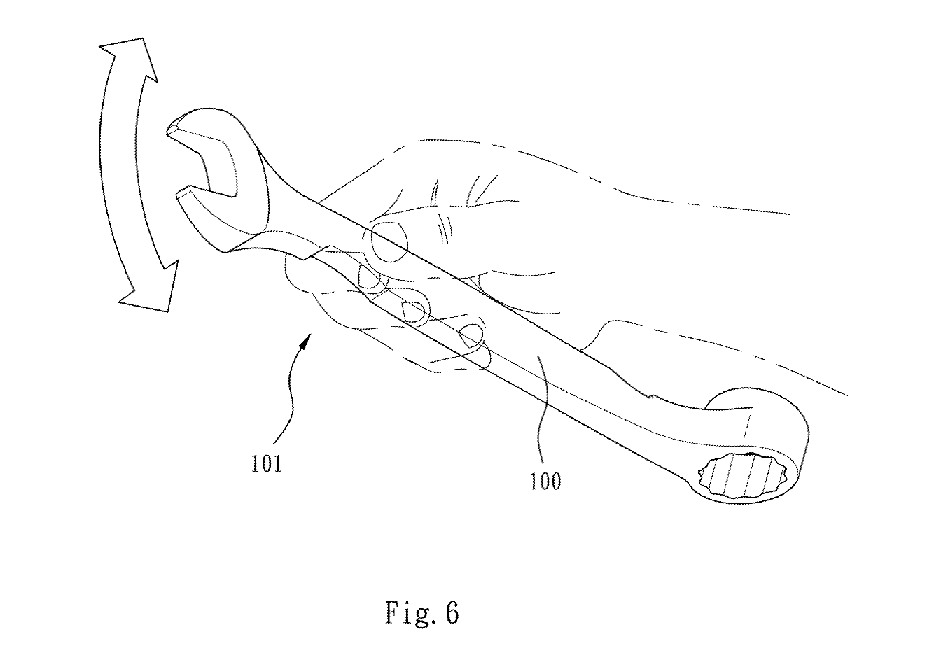

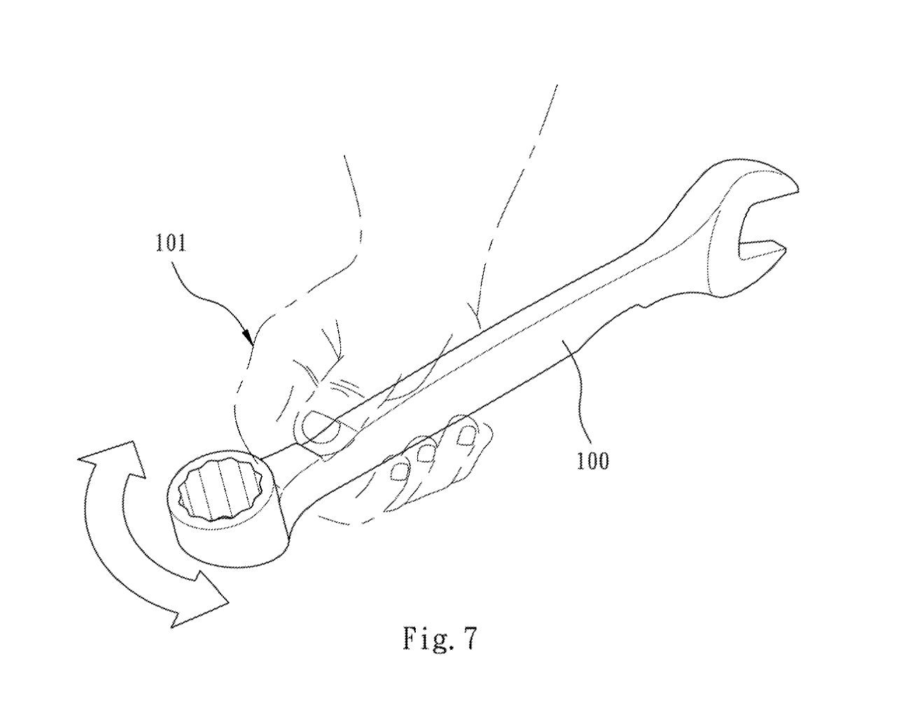

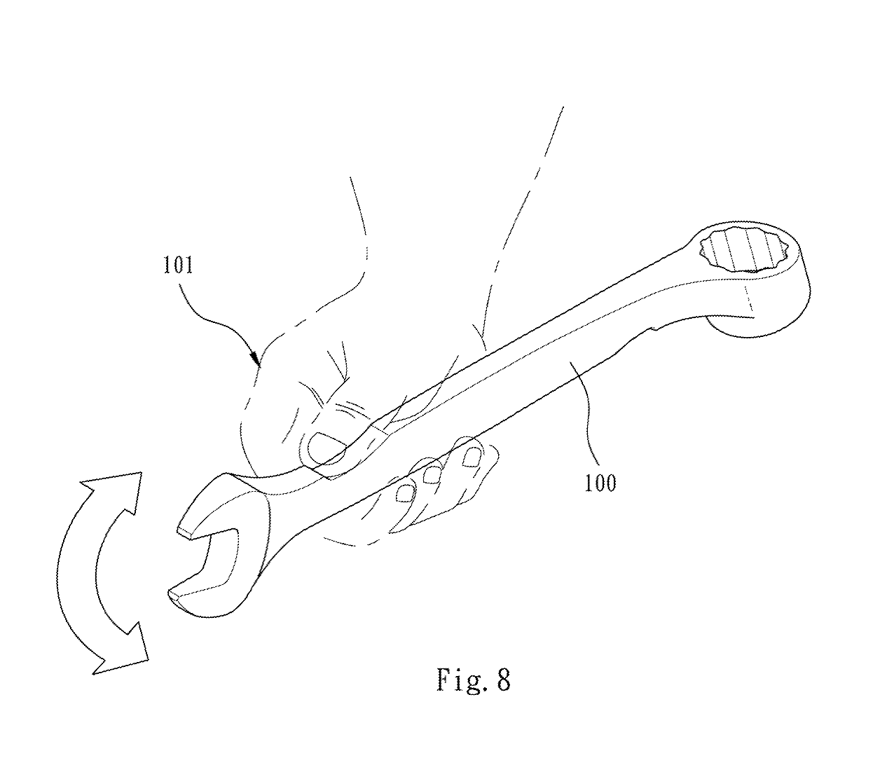

FIGS. 6-8 are schematic views of the wrench of FIG. 1 in operating mode. Users may use the wrench to turn workpieces such as fasteners by the open drive portion 200 or the closed drive portion 300. No matter which drive portion is used, at least one of the recessed structures 101 will prevent slipping during operation. For example, the recessed structure 101 can hook the index finger of users in one operating mode or the recessed structure 101 can restrain the thumb of users in another operating mode.

As described above, the present disclosure has the following advantages:

1. The wrench can prevent slipping and provide smoother operation because the recessed structure 101 can hook or restrain the fingers of users during operation.

2. The wrench can be held comfortably and applied force easily because M2/M1 is 0.45-0.8, wherein M1 is the maximum distance in parallel with the extending axis A3 of the handle 100 between the open drive portion 200 and the closed drive portion 300, and M2 is the maximum distance in parallel with the extending axis A3 of the handle 100 between the recessed structures 101.

3. Operation of the wrench will be ergonomic because the handle 100 is a quadrilateral shape where the distance D1 between the first side 110 and the second side 120 is greater than the distance D2 between the third side 130 and the fourth side 140, and the recessed structures 101 are formed on the first side 110 and the second side 120, respectively, and the working axis A1 is perpendicular to the working axis A2.

4. The wrench can adapt to varied operating environments because the abutting plane 210 and the abutting plane 310 can make the wrench keep an adequate operating angle, and the thickness T1 of the open drive portion 200 and the thickness T2 of the closed drive portion 300 are gradually decreased from the ends of the handle 100, respectively.

Although the present disclosure has been described in considerable detail with reference to certain embodiments thereof, other embodiments are possible. Therefore, their spirit and scope of the appended claims should no be limited to the description of the embodiments container herein.

It will be apparent to those skilled in the art that various modifications and variations can be made to the structure of the present disclosure without departing from the scope or spirit of the invention. In view of the foregoing, it is intended that the present disclosure cover modifications and variations of this invention provided they fall within the scope of the following claims.

What is claimed is:

1. A wrench, comprising:
a handle comprising:
a first side;
a second side opposite to the first side;
a first recessed structure formed on the first side; and
a second recessed structure formed on the second side, wherein the first recessed structure and the second recessed structure are near two ends of the handle, respectively;
an open drive portion located at the end of the handle; and
a closed drive portion located at the other end of the handle;
wherein the first side is toward a working direction of the open drive portion, a maximum distance in parallel with an extending axis of the handle between the open drive portion and the closed drive portion is M1, a maximum distance in parallel with the extending axis of the handle between the first recessed structure and the second recessed structure is M2, and M2/M1 is 0.45-0.8.

2. The wrench of claim 1, wherein the open drive portion has a first working axis, the closed drive portion has a second working axis, and the first working axis is perpendicular to the second working axis.

3. The wrench of claim 2, wherein the handle comprises:
a third side connected to the first side and the second side; and
a fourth side opposite to the third side and connected to the first side and the second side, wherein a distance between the first side and the second side is greater than a distance between the third side and the fourth side.

4. The wrench of claim 3, wherein a thickness of the open drive portion parallel to the first working axis is gradually decreased from the end of the handle, and a thickness of the closed drive portion parallel to the second working axis is gradually decreased from the other end of the handle.

5. The wrench of claim 3, wherein the first working axis of the open drive portion or the second working axis of the closed drive portion does not meet the extending axis of the handle.

6. The wrench of claim 1, wherein M2/M1 is 0.5-0.65.

7. A wrench, comprising:
a handle comprising:
a first side;
a second side opposite to the first side;
a first recessed structure formed on the first side; and
a second recessed structure formed on the second side, wherein the first recessed structure and the second recessed structure are near two ends of the handle, respectively;
an open drive portion having a first abutting plane and located at the end of the handle; and
a closed drive portion having a second abutting plane and located at the other hand of the handle;
wherein a first angle is formed between the first abutting plane and an extending axis of the handle, a second angle is formed between the second abutting plane and the extending axis of the handle, the first side is toward a working direction of the open drive portion, a maximum distance in parallel with the extending axis of the handle between the open drive portion and the closed drive portion is MI, a maximum distance in parallel with the extending axis of the handle between the first recessed structure and the second recessed structure is M2, and M2/M1 is 0.45-0.8.

8. The wrench of claim 7, wherein the handle comprises:
a third side connected to the first side and the second side; and
a fourth side opposite to the third side and connected to the first side and the second side, wherein a distance between the first side and the second side is greater than a distance between the third side and the fourth side.

9. The wrench of claim 7, wherein the open drive portion has a first working axis, the closed drive portion has a second working axis, a thickness of the open drive portion parallel to the first working axis is gradually decreased from the end of the handle, and a thickness of the closed drive portion parallel to the second working axis is gradually decreased from the other end of the handle.

10. The wrench of claim 7, wherein the open drive portion has a first working axis, the closed drive portion has a second working axis, and the first working axis or the second working axis does not meet the extending axis of the handle.

11. The wrench of claim 7, wherein the open drive portion has a first working axis, the closed drive portion has a second working axis, and the first working axis is perpendicular to the second working axis.

12. The wrench of claim 11, wherein the first recessed structure comprises a first curved surface and a first retaining surface connecting the first curved surface, and the second recessed structure comprises a second curved surface and a second retaining surface connecting the second curved surface.

13. The wrench of claim 7, wherein M2/M1 is 0.5-0.65.
